(19) United States
(12) Patent Application Publication
(10) Pub. No.: US 2014/0347224 A1
(43) Pub. Date: Nov. 27, 2014

(54) HANDHELD TERMINAL, WIRELESS COMMUNICATION SYSTEM, AND LOCATOR-POSITION ANNUNCIATION METHOD

(71) Applicant: Panasonic Corporation, Osaka (JP)

(72) Inventors: Shinya Hokazono, Fukuoka (JP); Takashi Watanabe, Fukuoka (JP); Katsumi Nakagawa, Fukuoka (JP)

(21) Appl. No.: 14/364,911

(22) PCT Filed: Oct. 2, 2013
(86) PCT No.: PCT/JP2013/005882

§ 371 Date: Jun. 12, 2014

(30) Foreign Application Priority Data
Oct. 10, 2012 (JP) 2012-225447

(51) Int. Cl. G01S 11/06; G01S 1/68

(52) U.S. Cl. CPC G01S 11/06; G01S 1/68
USPC 342/458

(57) ABSTRACT

A handheld terminal that makes it easy to identify the position of a locator. Said handheld terminal (100) is provided with the following: a wireless unit (130) that receives a radio signal transmitted by the locator; an RSSI detection unit (150) that measures the strength of the received radio signal; a distance-information determination unit (211) that, on the basis of the measured received signal strength, determines distance information that indicates a distance level between the wireless unit (130) and the locator; and an annunciation unit (240) that outputs the determined distance information.

### TECHNICAL FIELD

The present invention relates to a mobile terminal, a wireless communication system, and a locator position indicating method for searching for the position of a locator.

### BACKGROUND ART

In order to prevent articles from being lost, attaching a locator to a target article has been wide-spread. The term “locator” refers to a device capable of outputting a sound or the like to indicate its own position (see Patent Literature (hereinafter, abbreviated as “PTL”) 1, for example).

In a system (hereinafter, referred to as a “related art”) disclosed in PTL 1, a locator outputs a sound indicating proximity to a mobile terminal upon receiving a specific radio signal transmitted from the mobile terminal. Thus, a user can determine whether or not the locator is positioned within a range where a radio signal can be received (hereinafter, referred to as a “detection area”).

### CITATION LIST

### Patent Literature

### PTL 1

Japanese Patent Application Laid-Open No. HEI 10-45221

### SUMMARY OF INVENTION

### Technical Problem

Meanwhile, there are cases in which a more specific position of a locator has to be identified. For example, the user may desire to immediately use an article to which a locator is attached. However, in the related art, it is possible to determine only whether or not the locator is positioned within the detection area.

It is an object of the present invention to provide a mobile terminal, a wireless communication system, and a locator position indicating method that make it possible to easily identify the position of a locator.

### Solution to Problem

A mobile terminal of this disclosure includes: a radio section that receives a radio signal transmitted from a locator; an RSSI detecting section that measures received signal strength of the received radio signal; a distance information determining section that determines distance information indicating a level of a distance between the radio section and the locator, based on the measured received signal strength; and an indicating section that outputs the determined distance information.

A wireless communication system according to this disclosure includes a locator; and a mobile terminal, in which the locator includes a locator radio section that transmits a radio signal, and the mobile terminal includes: a radio section that receives the radio signal transmitted from the locator; an RSSI detecting section that measures received signal strength of the received radio signal; a distance information determining section that determines distance information indicating a level of a distance between the radio section and the locator, based on the measured received signal strength; and an indicating section that outputs the determined distance information.

A locator position indicating method according to this disclosure includes: receiving, by a radio section, a radio signal transmitted from a locator; measuring received signal strength of the received radio signal; determining distance information indicating a level of a distance between the radio section and the locator, based on the measured received signal strength; and outputting the determined distance information.

### Advantageous Effects of Invention

According to the mobile terminal, the wireless communication system, and the locator position indicating method of the present disclosure, it is made possible to easily identify the position of a locator.

### BRIEF DESCRIPTION OF DRAWINGS

FIG. 1 is a system configuration diagram illustrating an exemplary configuration of a wireless communication system according to the present embodiment;

FIG. 2 is a block diagram illustrating an exemplary configuration of a base unit according to the present embodiment;

FIG. 3 is a timing chart illustrating exemplary operations of a base unit, a mobile terminal and a locator during a normal state of a wireless communication system according to the present embodiment;

FIG. 4 is a block diagram illustrating an exemplary configuration of a mobile terminal according to the present embodiment;

FIG. 5 is a schematic diagram illustrating an exemplary distance information table according to the present embodiment;

FIGS. 6A to 6C are schematic diagrams illustrating a relation between a locator distance and an RSSI value according to the present embodiment;

FIG. 7 is a block diagram illustrating an exemplary configuration of a locator according to the present embodiment;

FIG. 8 is a flowchart illustrating an exemplary operation of a mobile terminal according to the present embodiment;

FIG. 9 is a flowchart illustrating an exemplary operation of a locator according to the present embodiment; and

FIGS. 10A to 10C are schematic diagrams each illustrating how distance information is outputted in a mobile terminal according to the present embodiment.

### DESCRIPTION OF EMBODIMENTS

Hereinafter, an extension telephone system including a mobile terminal, a base unit, and a locator will be described in detail with reference to the accompanying drawings as an exemplary embodiment of a wireless communication system according to the present invention.

First, a configuration of the wireless communication system according to the present embodiment will be described.

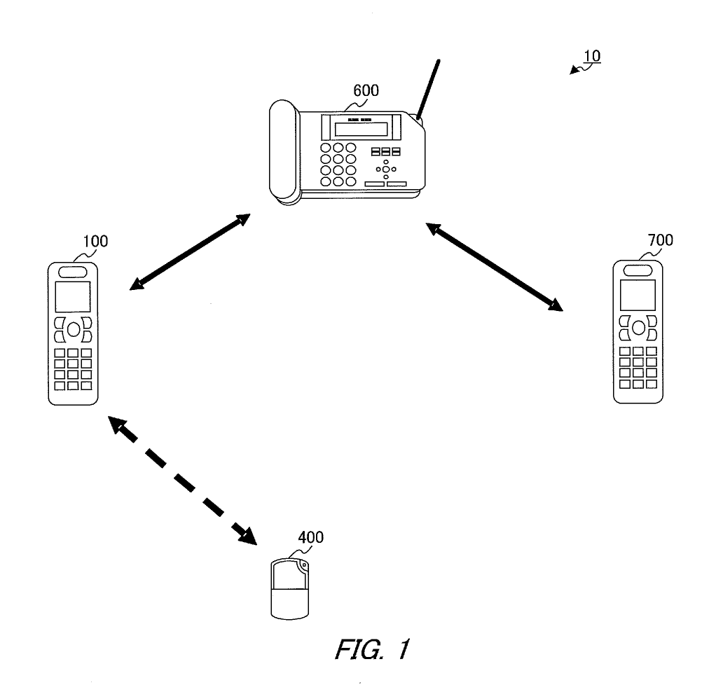

FIG. 1 is a system configuration diagram illustrating an exemplary configuration of the wireless communication system according to the present embodiment.

Referring to FIG. 1, wireless communication system 10 includes base unit 600, mobile terminal 100, mobile terminal 700, and locator 400.

Base unit 600 is an apparatus that serves as a basis for synchronization between base unit 600 and each of mobile terminal 100 and mobile terminal 700. Mobile terminal 100 and mobile terminal 700 are slave apparatuses that follow the synchronization reference of base unit 600. Locator 400 is a slave apparatus that follows the synchronization reference of mobile terminal 100 (here, mobile terminal 100 at the left side of FIG. 1). Mobile terminal 100 is a mobile communication terminal such as a wireless handset of a cordless telephone system, or a portable information terminal (personal digital assistance (PDA)).

In the present embodiment, wireless communication using a digital enhanced cordless telecommunications (DECT) protocol is assumed to be performed between base unit 600 and each of mobile terminal 100 and mobile terminal 700 (solid line arrows). Further, wireless communication using a protocol for locator 400 using a radio format for DECT is assumed to be performed between mobile terminal 100 and locator 400 (a dotted line arrow).

The configuration of mobile terminal 700 is identical to the configuration of mobile terminal 100, for example. Thus, in the following description, a description of mobile terminal 700 is omitted as appropriate.

The configuration of wireless communication system 10 has been described thus far.

Next, a configuration of base unit 600 will be described.

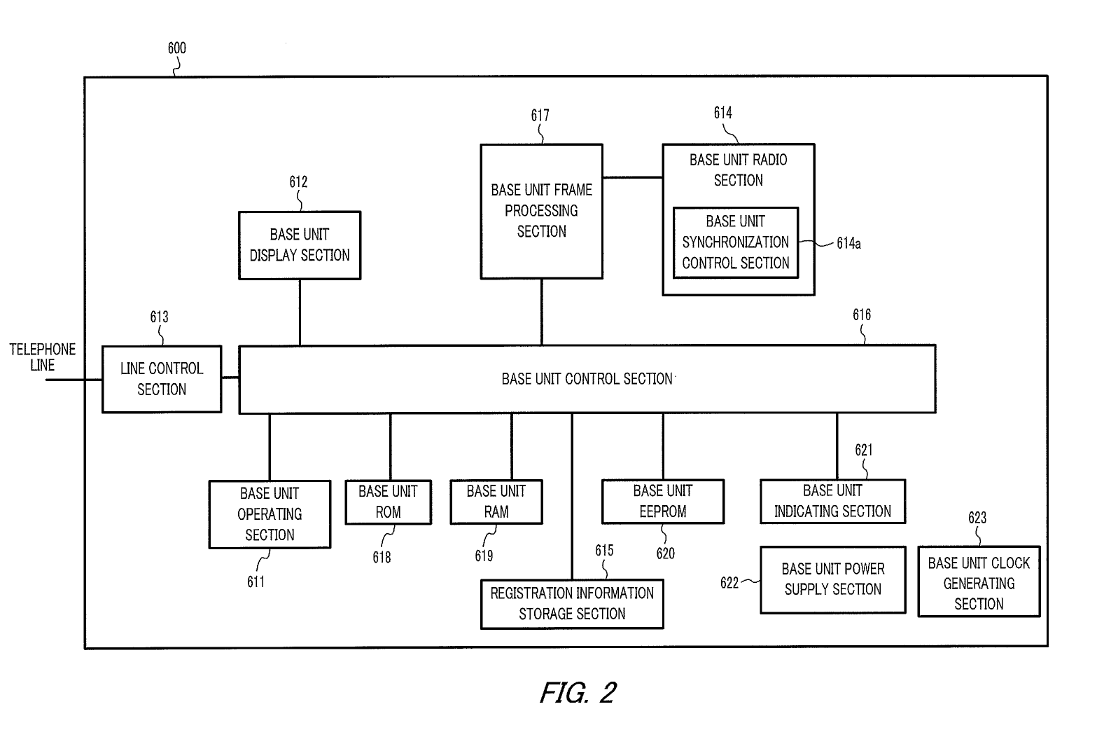

FIG. 2 is a block diagram illustrating an exemplary configuration of base unit 600.

Base unit 600 includes base unit operating section 611, base unit display section 612, line control section 613, base unit radio section 614, registration information storage section 615, base unit control section 616, and base unit frame processing section 617. Base unit 600 further includes base unit read only memory (ROM) 618, base unit random access memory (RAM) 619, base unit electrically erasable programmable read-only memory (EEPROM) 620, base unit indicating section 621, base unit power supply section 622, and base unit clock generating section 623.

Base unit radio section 614 performs wireless communication with mobile terminal 100 and mobile terminal 700 using a communication protocol such as time division multiple access (TDMA) or time division duplex (TDD). In the present embodiment, for example, wireless communication is performed using the DECT protocol. Line control section 613 of base unit 600 performs communication with a wired telephone line network.

Base unit clock generating section 623 generates a reference clock that is used to operate each section of base unit 600 and determines a communication timing of base unit radio section 614.

Base unit synchronization control section 614a installed in base unit radio section 614 determines a communication timing of a communication signal by base unit radio section 614 based on the reference clock of base unit clock generating section 623.

Next, an exemplary configuration of a communication frame in TDMA communication used in the present embodiment will be described.

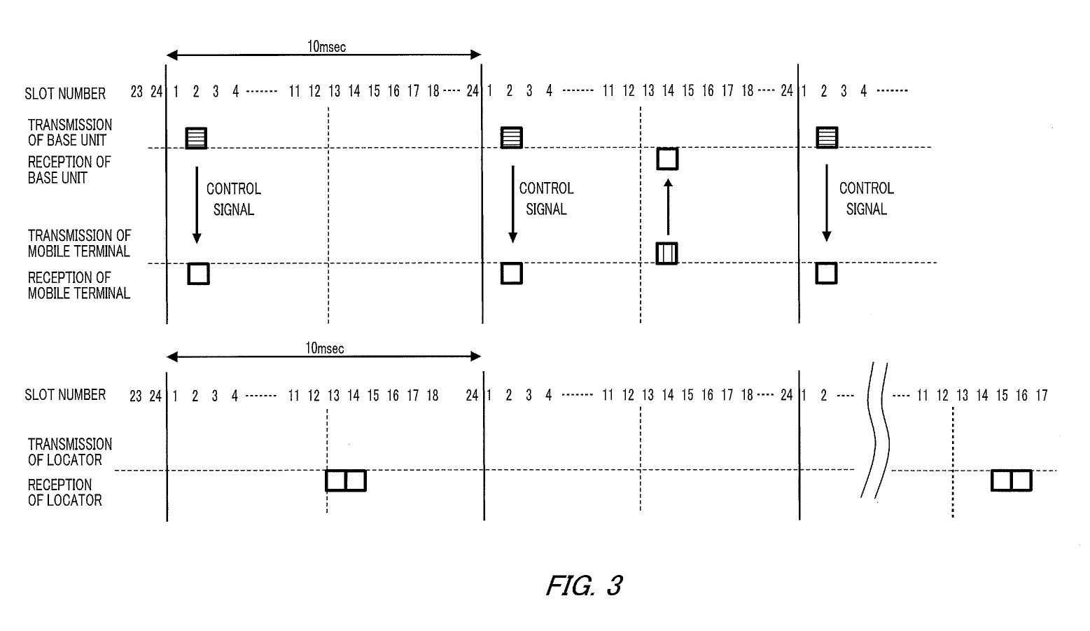

FIG. 3 illustrates exemplary operations of base unit 600, mobile terminal 100, and locator 400 in a normal state.

In wireless communication using the DECT, for example, a time division scheme in which communication is performed through a frame that has a duration of 10 msec and is divided into 24 slots as illustrated in FIG. 3 is used. Base unit 600 transmits a base unit ID using a control signal, and mobile terminal 100 acquires the base unit ID while receiving the control signal, then compares the received base unit ID with an ID of a base unit (registered base unit) for which base unit 100 stands by, and selects a base unit to synchronize with. Mobile terminal 100 does not perform transmission from mobile terminal 100 to base unit 600 through each frame during the standby state. Only when an event occurs (for example, a call is originated) in mobile terminal 100 or when mobile terminal 100 enters a call state, transmission from mobile terminal 100 to base unit 600 is performed. In this case, mobile terminal 100 selects certain slots for itself, and performs communication using uplink and downlink slots.

Usually, base unit 600 transmits a control signal through a certain slot that is determined for each frame. Such a control signal serving as a synchronous signal includes synchronous data (for example, syncword). The syncword is a predetermined known numerical string for timing synchronization, and serves as synchronous information used for synchronization with mobile terminal 100. The reception side starts extracting and acquiring a frame when the known numerical string is found.

In the DECT system, all communication is assigned a unique syncword, and the syncword is commonly included in signals transmitted by terminals. Even in a locator protocol to be described hereinafter, the same synchronization method is used. A locator paging signal to be transmitted by mobile terminal 100 includes a syncword, and thus locator 400 can be synchronized with mobile terminal 100.

The configuration of base unit 600 has been described thus far.

Next, a configuration of mobile terminal 100 will be described.

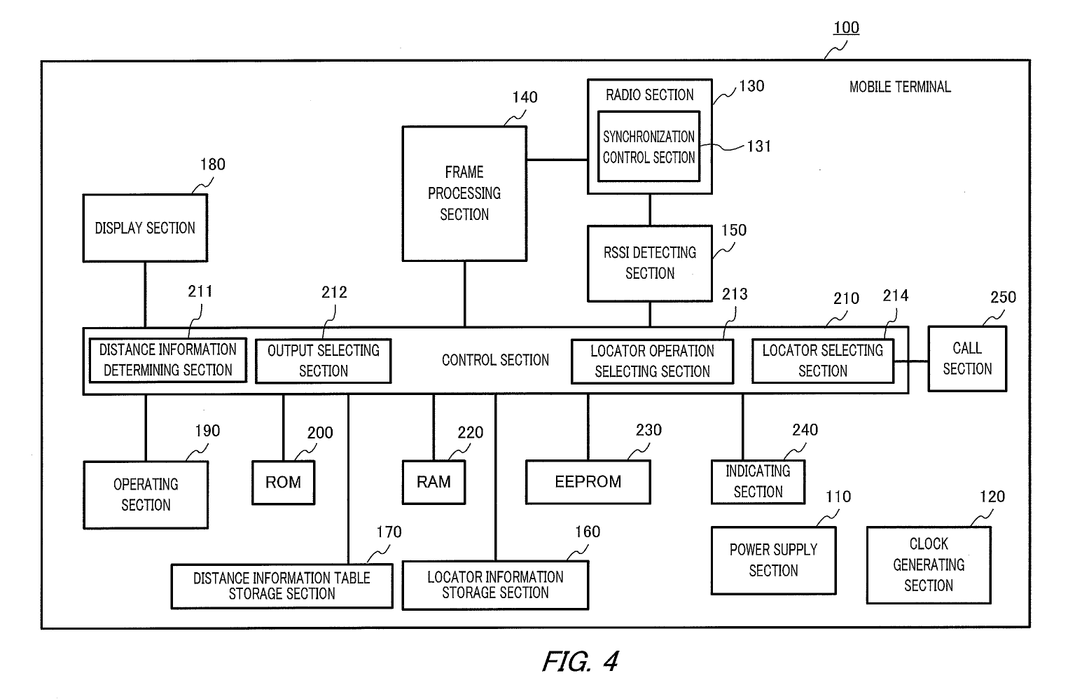

FIG. 4 is a block diagram illustrating an exemplary configuration of mobile terminal 100.

Referring to FIG. 4, mobile terminal 100 includes power supply section 110, clock generating section 120, radio section 130, frame processing section 140, received signal strength indication (RSSI) detecting section 150, locator information storage section 160, distance information table storage section 170, display section 180, operating section 190, ROM 200, control section 210, RAM 220, EEPROM 230, and indicating section 240. Further, mobile terminal 100 includes call section 250 configured of a speech amplifier, a speaker, and a microphone for a voice call, for example.

Power supply section 110 supplies electric power used to operate mobile terminal 100. For example, power supply section 110 includes a rechargeable battery pack.

Clock generating section 120 generates a clock signal used for an operation of each section of mobile terminal 100 based on the electric power supplied from power supply section 110. For example, clock generating section 120 includes a crystal oscillator circuit.

Radio section 130 receives a radio signal transmitted from a locator (not shown). For example, radio section 130 includes a radio antenna.

Synchronization control section 131 installed in radio section 130 determines a communication timing of a communication signal by radio section 130 based on a reference clock of clock generating section 120.

Frame processing section 140 embeds frame transmission information according to an operation mode at that time, and transfers the resultant data to radio section 130. Frame processing section 140 uses a DECT frame configuration when communication with base unit 600 is performed, and uses a locator frame configuration when communication with a locator is performed. Further, when communication with a locator is performed, frame processing section 140 performs communication according to a locator protocol in which the DECT system is changed for use in a locator.

In frame processing section 140, when the user performs a start operation for receiving a start operation and an end operation of a mode in which a locator search is performed (hereinafter, referred to as a “locator mode”) through operating section 190, frame processing section 140 transmits to a locator a locator paging signal to request transmission of a response signal. At this time, frame processing section 140 includes, in the locator paging signal, identification information of a locator selected by locator selecting section 214 to be described hereinafter. Further, frame processing section 140 includes, in the locator paging signal, instruction information indicating whether or not a locator selected by locator operation selecting section 213 to be described hereinafter is caused to sound.

RSSI detecting section 150 measures received signal strength of a radio response signal (hereinafter, referred to as a “locator response signal” received from a locator by radio section 130 in the locator mode.

Locator information storage section 160 stores in advance identification information of each locator as a target locator from which a radio signal is to be received (hereinafter, referred to as “locator information”).

Distance information table storage section 170 stores a distance information table in advance. The distance information table is a table describing the received signal strength of the radio signal and distance information indicating a level of a distance between radio section 130 and a locator in association with each other. The distance information is information indicating a difference in a level of a distance between radio section 130 and a locator (hereinafter, referred to as a “locator distance”). For example, the distance information is roughly classified into image information and sound information. The image information is information indicating a difference in a level of a locator distance using a difference in a text or a graphic. The sound information is information indicating a difference in a level of a locator distance using a difference in a sound.

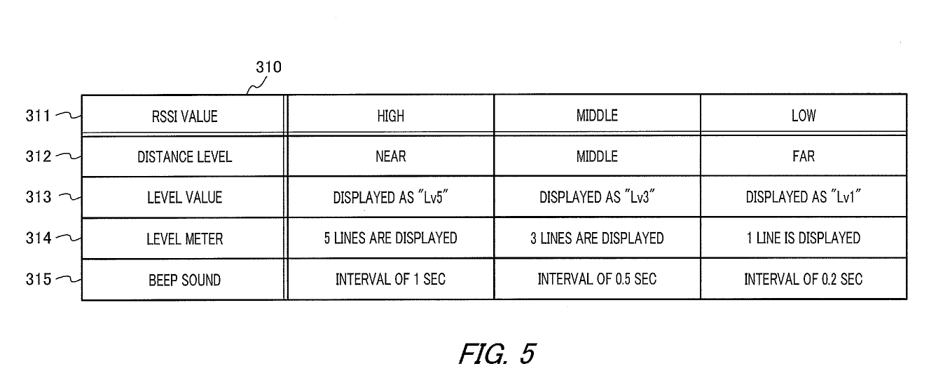

FIG. 5 is a schematic diagram illustrating an exemplary distance information table.

As illustrated in FIG. 5, in distance information table 310, for example, distance level 312, level value 313, level meter 314, and beep sound 315 are defined in association with RSSI value 311 indicating the received signal strength. Distance level 312 indicates a level of a locator distance, and is not always necessary unless text information is used. Level value 313 and level meter 314 are image information. Beep sound 315 is sound information.

Here, a relation between a locator distance and RSSI value 311 will be briefly described.

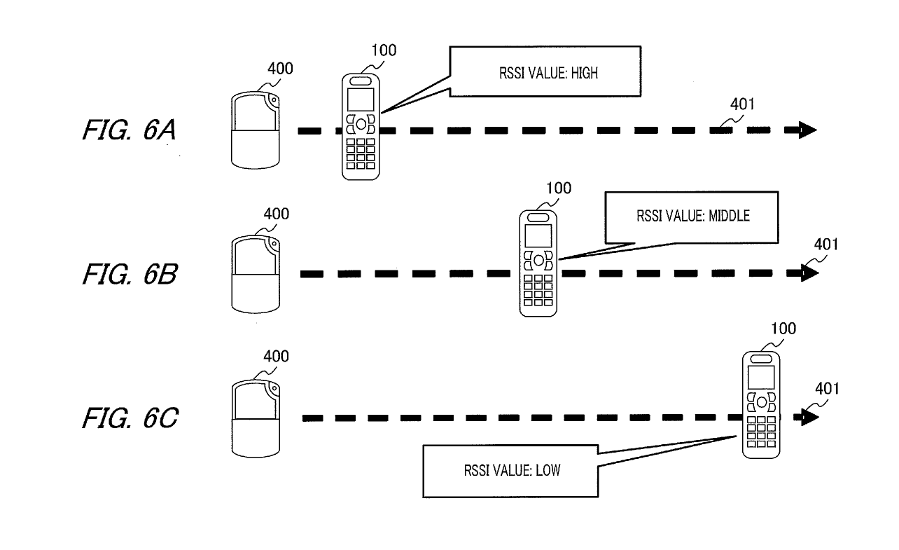

FIGS. 6A to 6C are schematic diagrams illustrating a relation between a locator distance and RSSI value 311.

Typically, the RSSI value is inversely proportional to the square of a distance from a radio wave generation source under the assumption that transmission power and surrounding environment are constant. Thus, when radio signal 401 is transmitted from locator 400 at constant transmission power, the RSSI value in mobile terminal 100 has a high value when mobile terminal 100 is positioned near locator 400 as illustrated in FIG. 6A. Further, when mobile terminal 100 is somewhat away from locator 400, the RSSI value has a middle value as illustrated in FIG. 6B. Further, when mobile terminal 100 is far away from locator 400, the RSSI value has a low value as illustrated in FIG. 6C.

It is possible to estimate a level of a locator distance using an RSSI value based on such a relation between a locator distance and RSSI value 311.

Display section 180 of FIG. 4 displays the locator information stored in locator information storage section 160 as options. Display section 180 is also used to output distance information. For example, display section 180 includes a liquid crystal display (LCD).

Operating section 190 receives various kinds of operations from the user. For example, operating section 190 includes a touch panel arranged on the surface of the LCD.

ROM 200 stores a control program and various kinds of data used by control section 210.

Control section 210 operates based on the clock signal generated in clock generating section 120, and controls an operation of entire mobile terminal 100. For example, control section 210 includes a central processing unit (CPU). Control section 210 executes the control program stored in ROM 200 and implements, for example, the functions of distance information determining section 211, output selecting section 212, locator operation selecting section 213, and locator selecting section 214.

Distance information determining section 211 determines distance information corresponding to the received signal strength measured by RSSI detecting section 150 with reference to the distance information table stored in distance information table storage section 170.

Output selecting section 212 receives a selection of whether the distance information is outputted by either or both of displaying image information on the screen and outputting sound information, through operating section 190.

Locator operation selecting section 213 receives a selection of whether or not locator 400 is caused to sound by the user through operating section 190, and transmits instruction information indicating the received selection to locator 400 through frame processing section 140.

Locator selecting section 214 receives identification information selected by the user through operating section 190.

RAM 220 and EEPROM 230 serve as a working memory of control section 210.

Indicating section 240 outputs distance information based on the received signal strength measured by RSSI detecting section 150 and according to the selection received through output selecting section 212.

Further, although it will be described later, the locator response signal to the locator paging signal is transmitted from only locator 400 corresponding to the identification information included in the locator paging signal. Thus, indicating section 240 outputs only distance information for locator 400 selected through locator selecting section 214.

Mobile terminal 100 can indicate, to the user, the level of a distance between radio section 130 and any locator 400 (that is, a distance between mobile terminal 100 and any locator 400). Thus, the user can check a change in a level of distance while moving with mobile terminal 100 and can thus easily identify the direction in which locator 400 is positioned and the locator distance. In other words, using mobile terminal 100, the user can easily identify the position of locator 400.

The configuration of mobile terminal 100 has been described thus far.

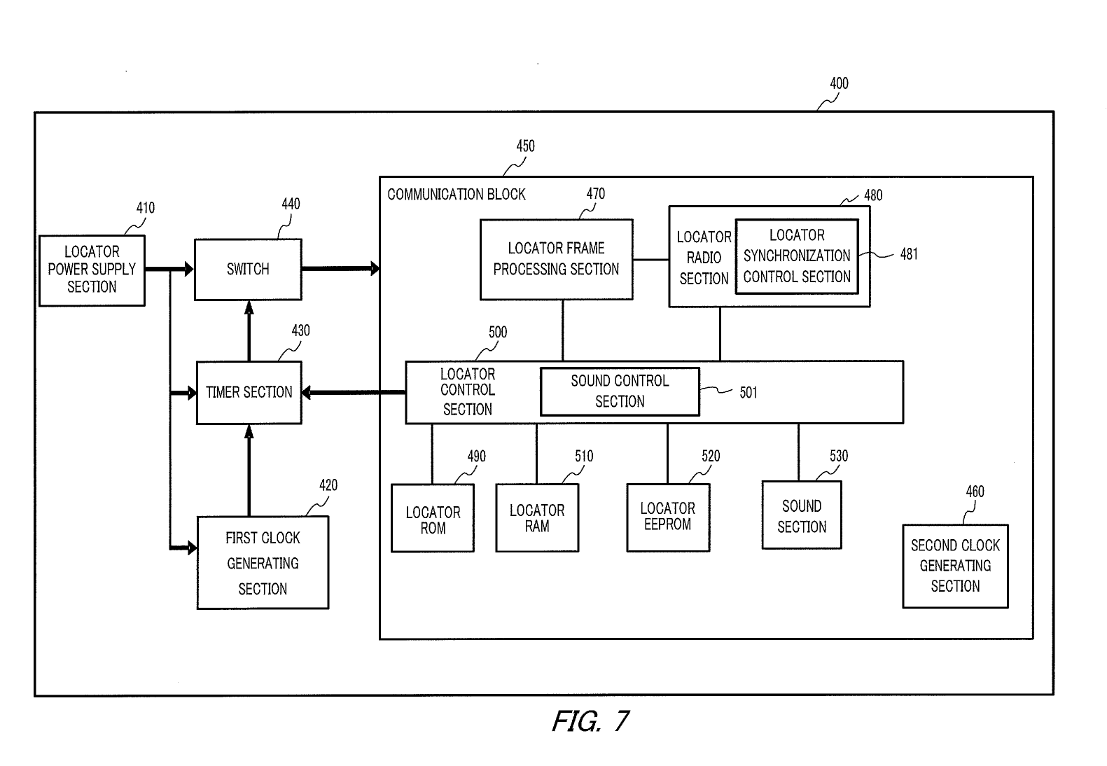

Next, a configuration of locator 400 will be described. FIG. 7 is a block diagram illustrating an exemplary configuration of locator 400.

Referring to FIG. 7, locator 400 includes locator power supply section 410, first clock generating section 420, timer section 430, switch 440, and communication block 450. Communication block 450 includes second clock generating section 460, locator radio section 480, locator frame processing section 470, locator ROM 490, locator control section 500, locator RAM 510, locator EEPROM 520, and sound section 530.

Locator power supply section 410 supplies electric power to operate locator 400. For example, locator power supply section 410 includes a battery.

First clock generating section 420 generates a clock signal used for an operation of timer section 430 based on the electric power continuously supplied from locator power supply section 410. For example, first clock generating section 420 includes a crystal oscillator circuit.

Timer section 430 counts a time period previously determined as a sleep period of communication block 450, and switches switch 440 from the OFF state to ON state each time the time period expires. In other words, low-speed clocks are supplied from first clock generating section 420 to timer section 430, and timer section 430 performs the counting process based on the low-speed clocks.

Timer section 430 records a value (expiration value) used to determine the sleep period in a register (not shown) thereof. Further, timer section 430 counts up according to the clocks from first clock generating section 420 in the sleep state, and stops the counting when the count value reaches the expiration value. At this time, timer section 430 notifies switch 440 that the counting has ended.

Switch 440 connects communication block 450 to the supply of electric power of locator power supply section 410 in the ON state, and blocks communication block 450 from the supply of electric power of locator power supply section 410 in the OFF state. Locator 400 performs an intermittent reception operation, and repeats an operation of returning from the sleep state at a predetermined cycle, performing the reception operation for a predetermined period of time, and then entering the sleep state. Switch 440 performs switching from the OFF state to the ON state according to the count end notification from timer section 430, and starts to supply electric power to communication block 450.

Second clock generating section 460 generates a clock signal used for an operation of each section of communication block 450 based on the electric power supplied from locator power supply section 410 via switch 440. For example, second clock generating section 460 includes a crystal oscillator circuit. Second clock generating section 460 supplies high-speed clocks faster than the low-speed clocks of first clock generating section 420 to each section of communication block 450, and a communication operation is controlled by the high-speed clocks.

Locator radio section 480 transmits a radio signal to mobile terminal 100. For example, locator radio section 480 includes a radio antenna.

Locator synchronization control section 481 installed in locator radio section 480 determines a communication timing of a communication signal by locator radio section 480 based on the reference clock of second clock generating section 460.

Locator frame processing section 470 performs communication with mobile terminal 100 through locator radio section 480. For example, locator frame processing section 470 includes a communication module that performs DECT (a registered trademark) communication with mobile terminal 100.

Further, locator frame processing section 470 transmits the locator response signal upon receiving the locator paging signal including the locator information of locator 400 itself from mobile terminal 100.

Locator ROM 490 stores a control program and various kinds of data used by locator control section 500.

Locator control section 500 operates based on the clock signal generated by second clock generating section 460, and controls an operation of entire communication block 450. For example, locator control section 500 includes a CPU. Locator control section 500 executes the control program stored in locator ROM 490, and implements, for example, a function of sound control section 501.

Sound control section 501 receives the instruction information included in the locator paging signal transmitted from mobile terminal 100 through frame processing section 140. Further, sound control section 501 controls an operation of sound section 530 according to the received instruction information.

Locator RAM 510 and locator EEPROM 520 serve as a working memory of locator control section 500.

Sound section 530 makes sound to indicate the position of locator 400. For example, sound section 530 includes a small speaker.

Upon receiving the locator paging signal directed to itself from mobile terminal 100, locator 400 can transmit the radio locator response signal. The locator response signal is used when mobile terminal 100 side measures the received signal strength. In other words, locator 400 can give mobile terminal 100 information necessary for outputting distance information.

Further, since a functional section that controls the ON/OFF operation of communication block 450 is provided, locator 400 can operate communication block 450 only when necessary, and thus can save power consumption.

In addition, during the sleep period, locator 400 can perform the counting process according to the low-speed clocks that are low in speed, so that second clock generating section 460 generating the high-speed clocks for communication does not have to be operated. Accordingly, locator 400 can save even more power consumption.

The configuration of locator 400 has been described so far.

Mobile terminal 100 performs wireless communication with locator 400 according to the locator protocol with the configurations of the respective apparatuses. Locator 400 is synchronized according to the locator paging signal (the synchronous signal) received from mobile terminal 100 serving as a master, and corrects a communication timing according to the reception timing of the locator paging signal.

Next, an operation of mobile terminal 100 will be described. Hereinafter, a description will be omitted of the processes of selecting a distance information outputting method, selecting whether or not a locator makes sound, and selecting a locator under the assumption that the description thereof has been already given.

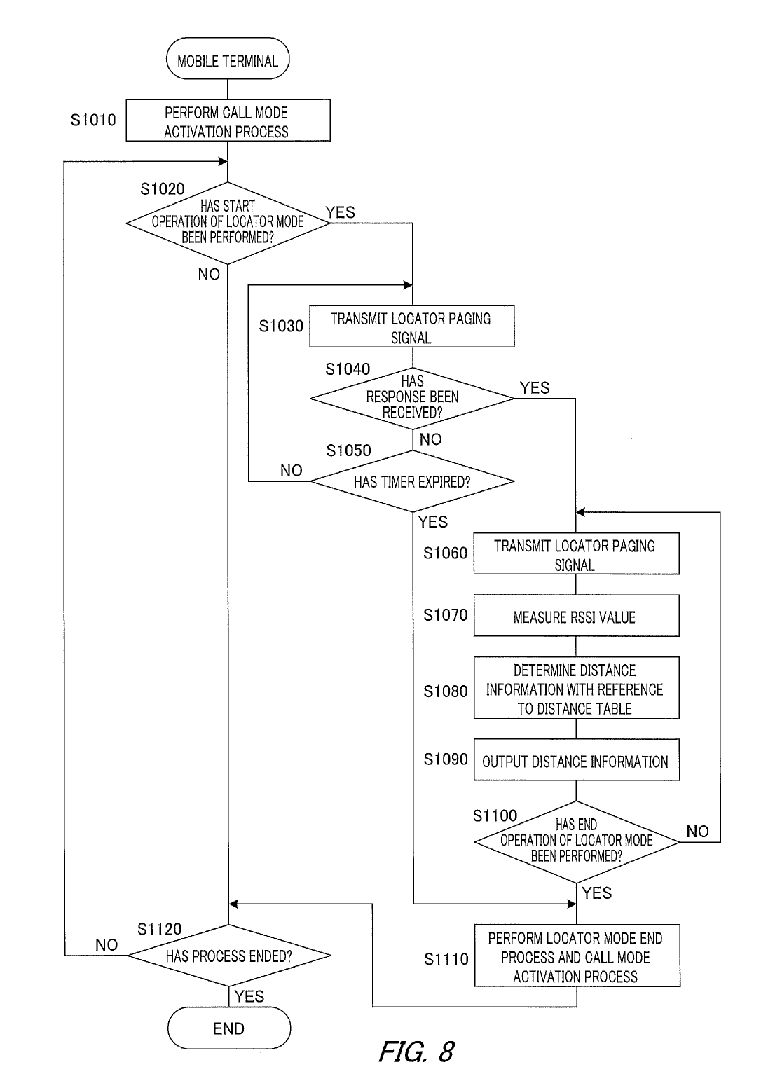

FIG. 8 is a flowchart illustrating an exemplary operation of mobile terminal 100.

First, in step S1010, control section 210 of mobile terminal 100 starts a call mode after the power supply is turned on and mobile terminal 100 thus starts its operation. Control section 210 gives an instruction to radio section 130 to receive a control signal from base unit 600, and performs a control such that mobile terminal 100 enters a standby state for base unit 600.

The call mode is a mode in which base unit 600 and mobile terminal 100 perform a voice call by radio in the extension telephone system. In the call mode, mobile terminal 100 can perform a phone call with another telephone connected via a public telephone line network through base unit 600. The functional part related to a call function may be not only call section 250 but also a functional part related to communication with locator 400 as a shared function part.

Then, in step S1020, frame processing section 140 determines whether or not the start operation of the locator mode has been performed. When the start operation of the locator mode is determined to have not been performed (NO in S1020), frame processing section 140 proceeds to step S1120 to be described hereinafter. However, when the start operation of the locator mode is determined to have been performed (YES in S1020), frame processing section 140 proceeds to step S1030. At this time, frame processing section 140 starts a timer (not shown), and starts counting an elapsed time from the start operation of the locator mode.

In step S1030, frame processing section 140 transmits the locator paging signal.

Then, in step S1040, frame processing section 140 determines whether or not the response (the locator response signal) has been received from locator 400. When the response is determined to have not been received (NO in S1040), frame processing section 140 proceeds to step S1050. However, when the response is determined to have been received (YES in S1040), frame processing section 140 proceeds to step S1060.

In step S1050, frame processing section 140 determines whether or not the count time of the timer has reached a predetermined value (whether or not the timer has expired). When the timer is determined to have not expired (NO in S1050), frame processing section 140 returns to step S1030, and repeats an operation of transmitting the locator paging signal and standing by for the response. Further, when the timer expires without reception of a response (YES in S1050), frame processing section 140 proceeds to step S1110 to be described hereinafter.

As described above, locator 400 performs an intermittent reception operation, and repeats an operation of returning from the sleep state at a predetermined cycle, performing the reception operation for a predetermined period of time, and then entering the sleep state. The reason why frame processing section 140 of mobile terminal 100 repeatedly transmits the locator paging signal is because mobile terminal 100 cannot know the timing for locator 400 to return from the sleep state. In addition, frame processing section 140 of mobile terminal 100 repeatedly transmits the locator paging signal to increase the possibility of the locator paging signal being received while locator 400 is performing the reception operation. Thus, the timer period of frame processing section 140 of mobile terminal 100 is preferably larger than the timer period of timer section 430 of locator 400.

In step S1060, frame processing section 140 transmits the locator paging signal.

Then, in step S1070, RSSI detecting section 150 measures the RSSI value indicating the received signal strength based on the response signal of locator 400.

Then, in step S1080, distance information determining section 211 determines distance information corresponding to the measured RSSI value with reference to the distance table (see FIG. 5).

Then, in step S1090, indicating section 240 outputs distance information corresponding to the RSSI value according to the selected distance information outputting method and selected locator 400.

Then, in step S1100, frame processing section 140 determines whether or not the end operation of the locator mode has been performed. When the end operation of the locator mode is determined to have not been performed (NO in S1100), frame processing section 140 returns to step S1060, and repeats an operation of transmitting the locator paging signal and outputting the distance information. However, when the end operation of the locator mode is determined to have been performed (YES in S1100), frame processing section 140 proceeds to step S1110.

In step S1110, mobile terminal 100 performs a process of ending the locator mode, and performs a process of activating the call mode.

Then, in step S1120, frame processing section 140 determines whether or not a process end instruction has been given by the user operation or the like. When the process end instruction is determined to have not been given (NO in S1120), frame processing section 140 returns to step S1020. However, when the process end instruction is determined to have been given (YES in S1120), frame processing section 140 ends the series of processes.

Mobile terminal 100 can indicate a level of a locator distance using an appropriate technique to the user using the operation described above.

The operation of mobile terminal 100 have been described thus far.

Next, the operation of locator 400 will be described.

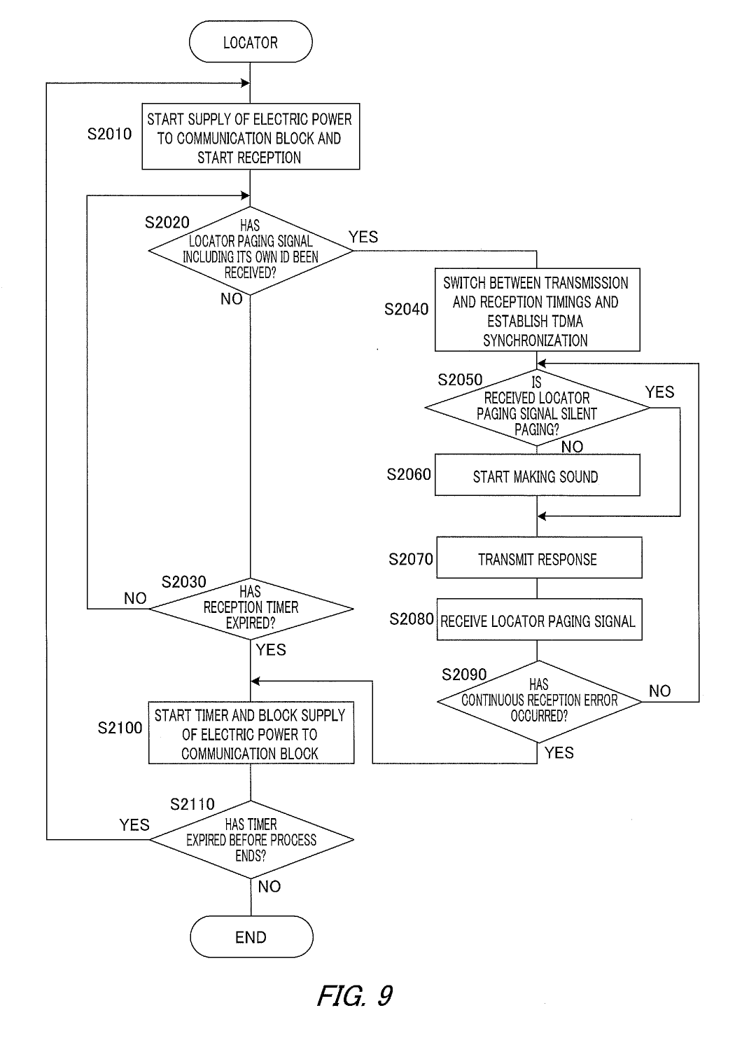

FIG. 9 is a flowchart illustrating an exemplary operation of locator 400.

First, in step S2010, timer section 430 controls switch 440 to start the supply of electric power to communication block 450, and the intermittent reception operation starts. As described above, locator 400 performs the reception operation for a predetermined period of time at a predetermined cycle, and during the reception operation, locator frame processing section 470 starts the timer (not shown), and starts counting the elapsed time since communication block 450 has started the reception. During the reception operation, locator 400 performs an operation of receiving the locator paging signal from mobile terminal 100.

Then, in step S2020, locator frame processing section 470 determines whether or not the locator paging signal including the locator information (its own ID) of locator 400 has been received. When the locator paging signal including its own ID is determined to have not been received (NO in S2020), locator frame processing section 470 proceeds to step S2030. However, when the locator paging signal including its own ID is determined to have been received (YES in S2020), locator frame processing section 470 proceeds to step S2040.

In step S2030, locator frame processing section 470 determines whether or not the count time of the timer has reached a predetermined value (whether or not a reception timer has expired). When the timer is determined to have not expired yet (NO in S2030), locator frame processing section 470 returns to step S2020, and continues standing by for reception of the locator paging signal including its own ID. However, when the timer has expired in a state in which the locator paging signal including its own ID is not received (YES in S2030), locator frame processing section 470 proceeds to step S2100 to be described hereinafter.

In step S2040, locator frame processing section 470 switches between transmission and reception timings, and establishes TDMA synchronization. As described above, the locator paging signal transmitted by mobile terminal 100 includes the syncword, and serves as the synchronous signal for synchronizing the locator. In the locator protocol, locator 400 is synchronized with mobile terminal 100 based on the locator paging signal transmitted by mobile terminal 100.

Then, in step S2050, sound control section 501 determines whether or not the received locator paging signal includes instruction information to instruct locator 400 not to make sound (silent paging). When the received locator paging signal is determined not to be the silent paging (NO in S2050), sound control section 501 proceeds to step S2060. However, when the received locator paging signal is determined to be the silent paging (YES in S2050), sound control section 501 proceeds to step S2070 to be described hereinafter.

In step S2060, sound control section 501 causes sound section 530 to start m. When step S2060 is bypassed, sound section 530 does not start making sound.

Then, in step S2070, locator frame processing section 470 transmits the response signal indicating the response to the locator paging signal. Then, after the supply of electric power starts, locator 400 continuously performs the reception operation for a predetermined period of time and continues to perform the process of steps S2070 to S2090.

In other words, in step S2080, locator frame processing section 470 receives the locator paging signal. Then, in step S2090, locator frame processing section 470 determines whether or not a continuous reception error of the locator paging signal has occurred.

When the continuous reception error is determined to have not occurred (NO in S2090), locator frame processing section 470 returns to step S2050, and repeats transmission of the response signal and reception of the locator paging signal. However, when the continuous reception error is determined to have occurred (YES in S2090), locator frame processing section 470 proceeds to step S2100. Further, even when the locator paging signal has not been received because the locator paging signal has not been transmitted in the first place, locator frame processing section 470 makes the same determination as when the continuous reception error has occurred, and then proceeds to step S2100.

In step S2100, locator control section 500 activates timer section 430, and causes locator 400 to transition to the sleep state. As a result, timer section 430 starts the process of counting the low-speed clocks received from first clock generating section 420, turns off switch 440, and blocks the supply of electric power to communication block 450.

Then, in step S2110, timer section 430 determines whether or not the count time has reached a value previously set as the length of the sleep period (whether or not the timer has expired). When the timer is determined to have not expired (NO in S2110), timer section 430 repeats checking the timer. As a result, the sleep state continues.

When the timer is determined to have expired before the process end instruction is given by the user operation or the like (YES in S2110), timer section 430 proceeds to step S2010, and starts the supply of electric power to communication block 450. As a result, communication block 450 of locator 400 starts the reception operation. Further, when the process end instruction is given by the user operation or the like while communication block 450 is operating (before the timer expires), timer section 430 ends a series of processes.

Locator 400 can transmit the response signal upon receiving the locator paging signal directed to locator 400 itself from mobile terminal 100 using the operation described above.

Further, locator 400 can distinguish the locator paging signal transmitted only to locator 400 from mobile terminal 100 based on the ID information. Further, locator 400 can determine whether or not the locator paging signal is silent paging and thus can turn on or off the sound function according to the instruction given from mobile terminal 100.

For example, let us assume a case where mobile terminal 100 performs setting so as to turn OFF the sound of the locator. In this case, mobile terminal 100 transmits a locator paging signal including the ID information unique to locator 400 of a paging target. At this time, mobile terminal 100 includes information indicating that the locator paging signal is “silent paging” in the locator paging signal, and transmits the resultant locator paging signal.

As a result, mobile terminal 100 can control locator 400 such that locator 400 transmits a response signal without making sound even when locator 400 is paged. Thus, the user can search for locator 400 without causing locator 400 to make sound, depending on circumstances.

The operation of locator 400 has been described thus far.

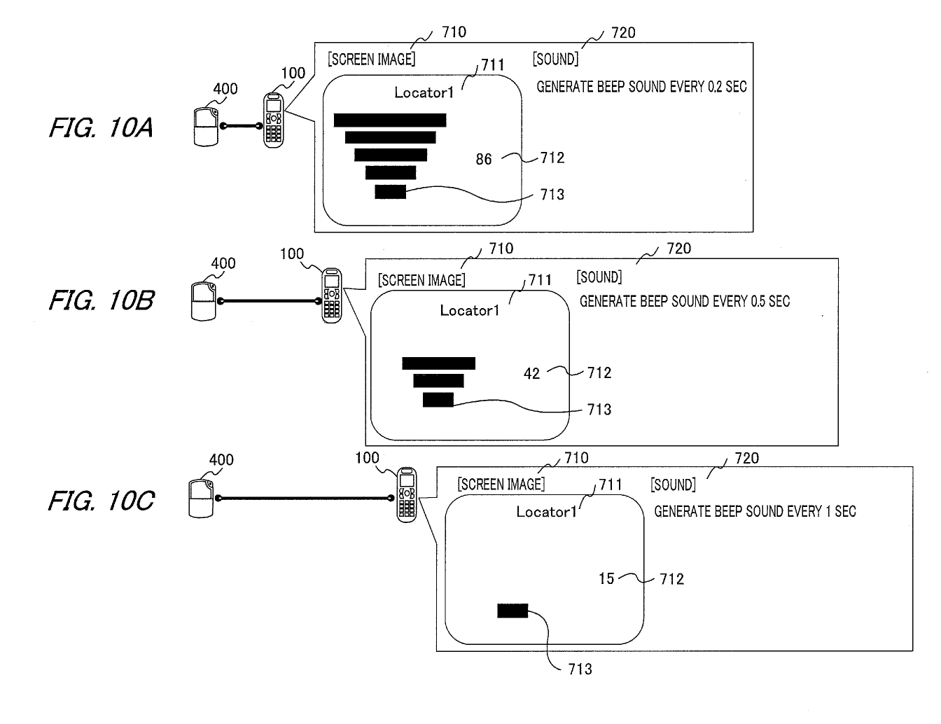

Next, a description will be given of how distance information is outputted in mobile terminal 100 will be described. FIGS. 10A to 10C are schematic diagrams each illustrating an example of how distance information is outputted in mobile terminal 100. FIG. 10A illustrates an example when a locator distance is short. FIG. 10B illustrates an example when a locator distance is middle. FIG. 10C illustrates an example when a locator distance is long.

For example, mobile terminal 100 outputs distance information using screen image 710 and sound 720 as illustrated in FIGS. 10A to 10C. For example, mobile terminal 100 displays locator information 711, RSSI value 712, and level meter 713 on screen image 710.

In the example of FIG. 10A, “Locator 1” is displayed as locator information 711, and “86” is displayed as RSSI value 712. In the example of FIG. 10B, “Locator 1” is displayed as locator information 711, and “42” is displayed as RSSI value 712. In the example of FIGS. 10A to 10C, a distance to locator 400 is visually displayed through level meter 713 in which the length of a lateral bar or the number of lateral bars changes.

Further, mobile terminal 100 makes a beep sound at sound 720. Mobile terminal 100 makes a beep sound every 0.2 seconds in the example of FIG. 10A, make a beep sound every 0.5 seconds in the example of FIG. 10B, and makes a beep sound every 1.0 second in the example of FIG. 10C. Further, the content of distance information outputted as described above is based on the content defined in the distance information table (see FIG. 5). In other words, mobile terminal 100 outputs the distance information indicating the level of the locator distance.

As the information is outputted in the way described above, the user can easily identify the direction in which locator 400 is positioned and the locator distance by checking a change in the level of distance, while moving with mobile terminal 100.

Further, indicating section 240 of mobile terminal 100 may not output sound information indicating a difference in the level of distance in a state in which the user has made a selection so that locator 400 does not make sound. In other words, mobile terminal 100 may perform outputting the distance information in such a way that the level of distance is displayed using only image information. As a result, the user can search for locator 400 without sound not only from mobile terminal 100 but also from locator 400 depending on circumstances.

As described above, in wireless communication system 10 according to the present embodiment, mobile terminal 100 measures the received signal strength of the radio signal transmitted from locator 400, and determines and outputs distance information based on the measurement result. Thus, the user can check a change in the distance information while moving, and thus can associate the moving direction with the change in the locator distance. Accordingly, the user can not only determine whether or not locator 400 is positioned within the detection area but also easily identify the direction in which locator 400 is positioned and thus move closer to locator 400. In other words, wireless communication system 10 according to the present embodiment makes it possible to easily identify the position of locator 400 for the user.

Moreover, wireless communication system 10 according to the present embodiment can turn off the sound of locator 400 so that distance information is outputted without sound. In other words, when mobile terminal 100 performs setting so as to turn off the sound of a locator, wireless communication system 10 according to the present embodiment transmits a locator paging signal including information indicating “silent paging” to the paging target locator. Then, locator 400 turns off the sound according to the “silent paging.” Thus, wireless communication system 10 according to the present embodiment makes it possible to identify the position of locator 400 without sound.

Further, wireless communication system 10 according to the present embodiment allows for a selection between displaying a screen image and outputting sound as the way to output distance information and allows for a selection between ON and OFF of the sound of locator 400. Thus, it is possible to identify the position of locator 400 in a state more appropriate to the surrounding environment or situation of the user.

Further, in wireless communication system 10 according to the present embodiment, when the RSSI value is displayed as the distance information, a change in a locator distance is well indicated, so that the position of locator 400 can be easily identified particularly when the locator distance is short.

Further, wireless communication system 10 according to the present embodiment makes it possible to intuitively and easily understand a change in a locator distance when a level value or a level meter is displayed as the distance information. Thus, wireless communication system 10 according to the present embodiment makes it possible to easily identify the position of locator 400 when a level value or a level meter is displayed as the distance information; particularly, when the locator distance is long.

Further, wireless communication system 10 according to the present embodiment not only makes it possible to intuitively and easily understand a change in a locator distance but also to eliminate the need for viewing the screen when sound is outputted as the distance information, so that the position of locator 400 can be promptly identified.

Furthermore, locator operation selecting section 213 of mobile terminal 100 may be configured to select to turn on the sound when a locator distance is not greater than a predetermined value (that is, when the RSSI value is not less than a predetermined value). In this case, sound section 530 of locator 400 makes sound on condition that the locator distance is not greater than the predetermined value.

When locator 400 is positioned far away, usually, the user of mobile terminal 100 cannot hear the sound even if the sound is made. Thus, as described above, setting locator 400 to make sound only when locator 400 is positioned nearby can avoid unnecessary sound and makes it possible to achieve a system capable of saving power consumption of locator 400, taking into consideration a surrounding sound environment.

As described above, a mobile terminal of this disclosure includes: a radio section that receives a radio signal transmitted from a locator; an RSSI detecting section that measures received signal strength of the received radio signal; a distance information determining section that determines distance information indicating a level of a distance between the radio section and the locator, based on the measured received signal strength; and an indicating section that outputs the determined distance information.

This mobile terminal can output the distance information indicating the level of the distance to the locator, and thus allows the user to easily identify the position of the locator.

The mobile terminal may further include a distance information table storage section that stores a distance information table in which a level of the received signal strength is associated with the distance information, and the distance information determining section may determine the distance information corresponding to the measured received signal strength with reference to the distance information table.

This mobile terminal can output appropriate distance information, and thus allows the user to more easily identify the position of the locator.

Further, in the mobile terminal, the distance information may be image information indicating a difference in the level of the distance using a difference in a text or graphic; and the indicating section may display the image information on a screen.

This mobile terminal can output a difference in the level of the distance using a difference in a text or graphic, and thus allows the user to easily identify the position of the locator even without sound information.

Furthermore, in the mobile terminal, the distance information may be sound information indicating a difference in the level of the distance using a difference in sound, and the indicating section may output the sound information.

This mobile terminal can output a difference in the level of the distance using a difference in sound, and thus allows the user to easily identify the position of the locator even without image information.

In the mobile terminal, the distance information may include image information indicating a difference in the level of the distance using a difference in a text or graphic and sound information indicating a difference in the level of the distance using a difference in sound. In addition, the mobile terminal may further include: an operating section that receives an operation from a user; and an output selecting section that receives a selection of whether the distance information is outputted by any one of or both of displaying the image information on a screen and outputting the sound information, the selection being made by the user through the operating section, and in the mobile terminal, the indicating section may output the distance information according to the selection received by the output selecting section.

This mobile terminal can output the distance information through a way appropriate to a condition such as a surrounding environment or situation of the user and thus allows the user to easily identify the position of the locator in a state in which restrictions due to various conditions are reduced.

This mobile terminal may further include: an operating section that receives an operation from a user; and a locator operation selecting section that receives a selection of whether or not the locator makes sound, the selection being made by a user through the operating section, and that transmits instruction information indicating the received selection to the locator through the radio section.

The mobile terminal can turn off the sound of the locator when a surrounding sound environment is noisy, and can auxiliarily use the sound of the locator in other environments, and thus allows the user to easily identify the position of the locator, taking into consideration a surrounding sonic environment.

In this mobile terminal, the indicating section may not output sound information indicating the level of the distance in a state in which a selection of making no sound in the locator is received from the user.

This mobile terminal can output the distance information of the locator without making sound from the mobile terminal and thus allows the user to easily identify the position of the locator, taking into consideration a surrounding sound environment.

This mobile terminal may further include: a locator information storage section that stores identification information of the locator in advance; a display section that displays the stored identification information as options; an operating section that receives an operation from a user; and a locator selecting section that receives the identification information selected by the user, through the operating section, and the indicating section may output the distance information for the locator corresponding to the selected identification information.

This mobile terminal can optionally designate a locator and output the distance information, so that even when there are a plurality of locators, the user can easily identify the position of an individual locator.

A wireless communication system according to this disclosure includes a locator; and a mobile terminal, in which the locator includes a locator radio section that transmits a radio signal, and the mobile terminal includes: a radio section that receives the radio signal transmitted from the locator; an RSSI detecting section that measures received signal strength of the received radio signal; a distance information determining section that determines distance information indicating a level of a distance between the radio section and the locator, based on the measured received signal strength; and an indicating section that outputs the determined distance information.

In this wireless communication system, the mobile terminal can output the distance information indicating the level of the distance to the locator, and thus the user can easily identify the position of the locator.

In this wireless communication system, the locator may further include a sound section that makes sound on condition that a distance between the locator and the mobile terminal is not greater than a predetermined value.

In the wireless communication system, it is possible to avoid unnecessary sound that cannot be heard by the user, and thus the user can easily identify the position of the locator while taking into consideration a surrounding sound environment and saving power consumption of the locator.

A locator position indicating method according to this disclosure includes: receiving, by a radio section, a radio signal transmitted from a locator; measuring received signal strength of the received radio signal; determining distance information indicating a level of a distance between the radio section and the locator, based on the measured received signal strength; and outputting the determined distance information.

In the locator position indicating method, the mobile terminal can output the distance information indicating the level of the distance to the locator, and thus the user can easily identify the position of the locator.

The disclosure of Japanese Patent Application No. 2012-225447, filed on Oct. 10, 2012, including the specification, drawings and abstract, is incorporated herein by reference in its entirety.

### INDUSTRIAL APPLICABILITY

The present invention is useful in a mobile terminal, a wireless communication system, and a locator position indicating method that make it possible to easily identify the position of a locator.

### REFERENCE SIGNS LIST

10 Wireless communication system
100, 700 Mobile terminal
110 Power supply section
120 Clock generating section
130 Radio section
131 Synchronization control section
140 Frame processing section
150 RSSI detecting section
160 Locator information storage section
170 Distance information table storage section
180 Display section
190 Operating section
200 ROM
210 Control section
211 Distance information determining section
212 Output selecting section
213 Locator operation selecting section
214 Locator selecting section
220 RAM
230 EEPROM
240 Indicating section
250 Call section
400 Locator
410 Locator power supply section
420 First clock generating section
430 Timer section
440 Switch
450 Communication block
460 Second clock generating section
470 Locator frame processing section
480 Locator radio section
481 Locator synchronization control section
490 Locator ROM
500 Locator control section
510 Locator RAM
520 Locator EEPROM
530 Sound section
600 Base unit
611 Base unit operating section
612 Base unit display section
613 Line control section
614 Base unit radio section
614a Base unit synchronization control section
615 Registration information storage section
616 Base unit control section
617 Base unit frame processing section
618 Base unit ROM
619 Base unit RAM
620 Base unit EEPROM
621 Base unit indicating section
622 Base unit power supply section
623 Base unit clock generating section

1. A mobile terminal, comprising:
a radio section that receives a radio signal transmitted from a locator;
an RSSI detecting section that measures received signal strength of the received radio signal;
a distance information determining section that determines distance information indicating a level of a distance between the radio section and the locator, based on the measured received signal strength; and
an indicating section that outputs the determined distance information.

2. The mobile terminal according to claim 1, further comprising a distance information table storage section that stores a distance information table in which a level of the received signal strength is associated with the distance information, wherein
the distance information determining section determines the distance information corresponding to the measured received signal strength with reference to the distance information table.

3. The mobile terminal according to claim 2, wherein:
the distance information is image information indicating a difference in the level of the distance using a difference in a text or graphic; and
the indicating section displays the image information on a screen.

4. The mobile terminal according to claim 2, wherein:
the distance information is sound information indicating a difference in the level of the distance using a difference in sound; and
the indicating section outputs the sound information.

5. The mobile terminal according to claim 2, wherein
the distance information includes image information indicating a difference in the level of the distance using a difference in a text or graphic and sound information indicating a difference in the level of the distance using a difference in sound, and
the mobile terminal further comprises:
an operating section that receives an operation from a user; and
an output selecting section that receives a selection of whether the distance information is outputted by any one of or both of displaying the image information on a screen and outputting the sound information, the selection being made by the user through the operating section, wherein
the indicating section outputs the distance information according to the selection received by the output selecting section.

6. The mobile terminal according to claim 2, further comprising:
an operating section that receives an operation from a user; and
a locator operation selecting section that receives a selection of whether or not the locator makes sound, the selection being made by a user through the operating section, and that transmits instruction information indicating the received selection to the locator through the radio section.

7. The mobile terminal according to claim 6, wherein the indicating section does not output sound information indicating the level of the distance in a state in which a selection of making no sound in the locator is received from the user.

8. The mobile terminal according to claim 2, further comprising:
a locator information storage section that stores identification information of the locator in advance;
a display section that displays the stored identification information as options;
an operating section that receives an operation from a user; and
a locator selecting section that receives the identification information selected by the user, through the operating section, wherein
the indicating section outputs the distance information for the locator corresponding to the selected identification information.

9. A wireless communication system, comprising:
a locator; and
a mobile terminal, wherein
the locator comprises a locator radio section that transmits a radio signal, and
the mobile terminal comprises:
a radio section that receives the radio signal transmitted from the locator;
an RSSI detecting section that measures received signal strength of the received radio signal;
a distance information determining section that determines distance information indicating a level of a distance between the radio section and the locator, based on the measured received signal strength; and
an indicating section that outputs the determined distance information.

10. The wireless communication system according to claim 9, wherein
the locator further comprises a sound section that makes sound on condition that a distance between the locator and the mobile terminal is not greater than a predetermined value.

11. A locator position indicating method, comprising:
receiving, by a radio section, a radio signal transmitted from a locator;
measuring received signal strength of the received radio signal;
determining distance information indicating a level of a distance between the radio section and the locator, based on the measured received signal strength; and
outputting the determined distance information.
